(19) United States
(12) Patent Application Publication
(10) Pub. No.: US 2016/0240147 A1
(43) Pub. Date: Aug. 18, 2016

(54) DISPLAY CONTROL APPARATUS AND CONTROL METHOD THEREOF

(71) Applicant: CANON KABUSHIKI KAISHA, Tokyo (JP)

(72) Inventor: Kazuya Kitada, Kawasaki-shi (JP)

(21) Appl. No.: 15/136,717

(22) Filed: Apr. 22, 2016

Related U.S. Application Data
(63) Continuation of application No. 13/323,689, filed on Dec. 12, 2011.

(30) Foreign Application Priority Data
Dec. 17, 2010 (JP) 2010-282225

(51) Int. Cl. G09G 3/34

(52) U.S. Cl. CPC G09G 3/342; G09G 2320/103; G09G 2320/062; G09G 2320/0626; G09G 2320/0233; G09G 2320/0242

(57) ABSTRACT

A display control apparatus includes a display control unit configured to display a predetermined object image on a display unit, and a light emission control unit configured to independently control light emission of a plurality of light emitting units corresponding to a plurality of division areas prepared by dividing the display unit, wherein, when a display area of the object image on the display unit is changed, the light emission control unit controls a plurality of division light emitting units other than the plurality of division light emitting units corresponding to the display area of the object image to emit light at a similar luminance to the luminance of the plurality of division light emitting units corresponding to the display area of the object image.

### CROSS-REFERENCE TO RELATED APPLICATIONS

This application is a continuation, and claims the benefit, of U.S. patent application Ser. No. 13/323,689, presently pending and filed on Dec. 12, 2011, and claims the benefit of, and priority to, Japanese Patent Application No. 2010-282225 filed Dec. 17, 2010, which applications are hereby incorporated by reference herein in their entireties.

### BACKGROUND OF THE INVENTION

1. Field of the Invention

The present invention relates to a display control apparatus having a light emission control unit capable of controlling light emission of a plurality of light emitting units independently from each other and a control method thereof.

2. Description of the Related Art

Conventionally, a liquid crystal display apparatus has a plurality of light emitting units (back light source units) each containing a plurality of light emitting elements arranged in a matrix state on the back side of a display area of a liquid crystal display panel. As the light emitting element for use in the light emitting unit, for example, fluorescent, light emitting diode (LED) and the like are available. The luminance of each light emitting element is controlled by an electric current value to be applied.

As discussed in Japanese Patent Application Laid-Open No. 2007-183608, the liquid crystal display apparatus can control independently light emission of each of the plurality of division light emitting units corresponding to a plurality of division areas prepared by dividing the display unit. Such a control is called local dimming control. If the local dimming control is performed when a locally low gradation area and a locally high gradation area are mixed in an image to be displayed, the luminance of each division light emitting unit corresponding to each area can be controlled independently, thereby intensifying a feeling of contrast among displayed colors.

As a technology for displaying an image sufficiently and uniformly in the image display area, a technology discussed in Japanese Patent Application Laid-Open No. 2008-83592 is available, the technology proposing turning on the division light emitting units corresponding to an area wider than a specified display area.

However, in the local dimming control on the light emitting units, when a user changes the display condition (display position, size of the display area, etc.) of an object image (of the graphical user interface (GUI)) on the display screen by his or her input operation or the like, the processing of the local dimming control cannot follow the change when the change is fast. For example, when the display position or the display area of the object image is changed faster than a predetermined velocity, the processing of the local dimming control cannot follow the change, thereby sometimes causing deterioration of the image such as color unevenness in the changed object image or periphery of the object image.

### SUMMARY OF THE INVENTION

One aspect of the present invention provides a display control apparatus having a light emission control unit capable of independently controlling light emission of a plurality of division light emitting units, where the display control apparatus is able to suppress deterioration of image quality, such as color unevenness, even if at least anyone of the display position and the display area of an object image is changed.

According to an aspect of the present invention, there is provided display control apparatus that includes a display control unit configured to control to display object image on a display unit, and a light emission control unit configured to independently control light emission of a plurality of division light emitting units corresponding to a plurality of division areas prepared by dividing a display area of the display unit, wherein, when a display area of the object image on the display unit is changed, the light emission control unit controls a plurality of division light emitting units other than the plurality of division light emitting units corresponding to the display area of the object image to emit light at a similar luminance to the luminance of the plurality of division light emitting units corresponding to the display area of the object image before the display area is changed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are block diagrams illustrating a display control system and a display control apparatus according to a first exemplary embodiment of the present invention.

FIGS. 2A and 2B are schematic diagrams illustrating an image displayed on a display unit and the plurality of division light emitting units in a light emitting unit.

FIG. 3 is a flow chart illustrating a processing of the display control apparatus according to the first exemplary embodiment.

FIGS. 4A, 4B and 4C are schematic diagrams illustrating a display image illustrating the display unit and a light emission state of the light emitting unit when the display position of the object image is changed in the first exemplary embodiment.

FIGS. 5A, 5B and 5C are schematic diagrams illustrating a display image on the display unit and a light emission state of the light emitting unit when the display area of the object image is changed in the first exemplary embodiment.

FIG. 6 is a block diagram illustrating a display control system according to a second exemplary embodiment.

FIG. 7 is a flow chart illustrating a processing of the display control apparatus according to the second exemplary embodiment.

FIGS. 8A, 8B and 8C are schematic diagrams illustrating a display image on the display unit and a light emission state of the light emitting unit when the display position of the object image is changed in the second exemplary embodiment.

FIGS. 9A, 9B and 9C are schematic diagrams illustrating a display image on the display unit and a light emission state of the light emitting unit when the display area of the object image is changed in the second exemplary embodiment.

### DESCRIPTION OF THE EMBODIMENTS

Various exemplary embodiments, features, and aspects of the invention will be described in detail below with reference to the drawings.

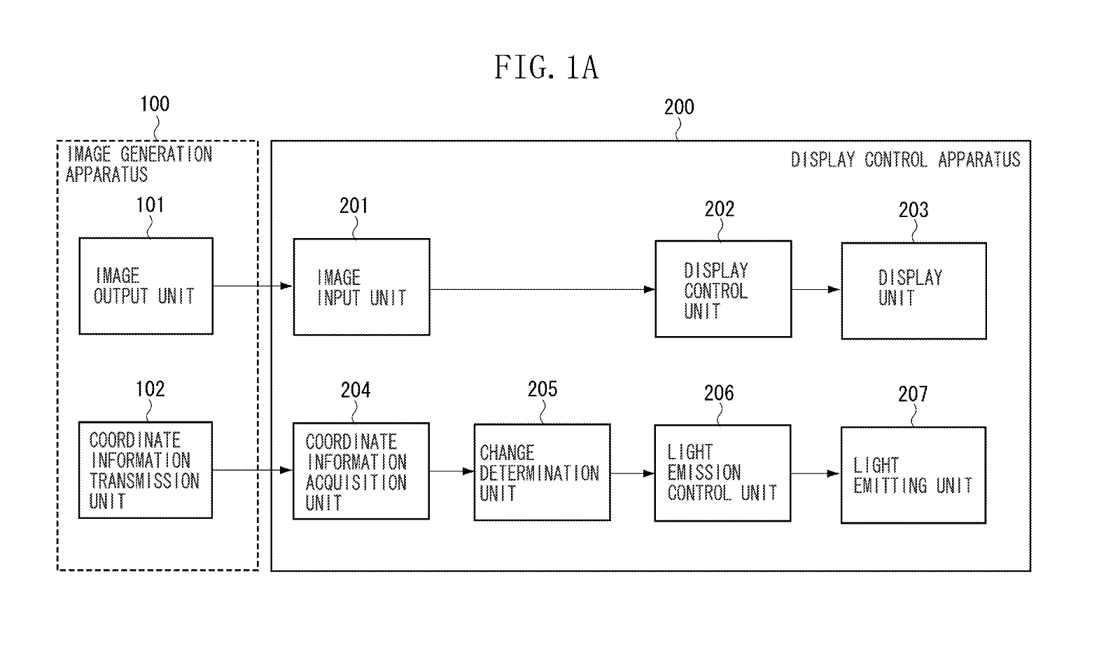

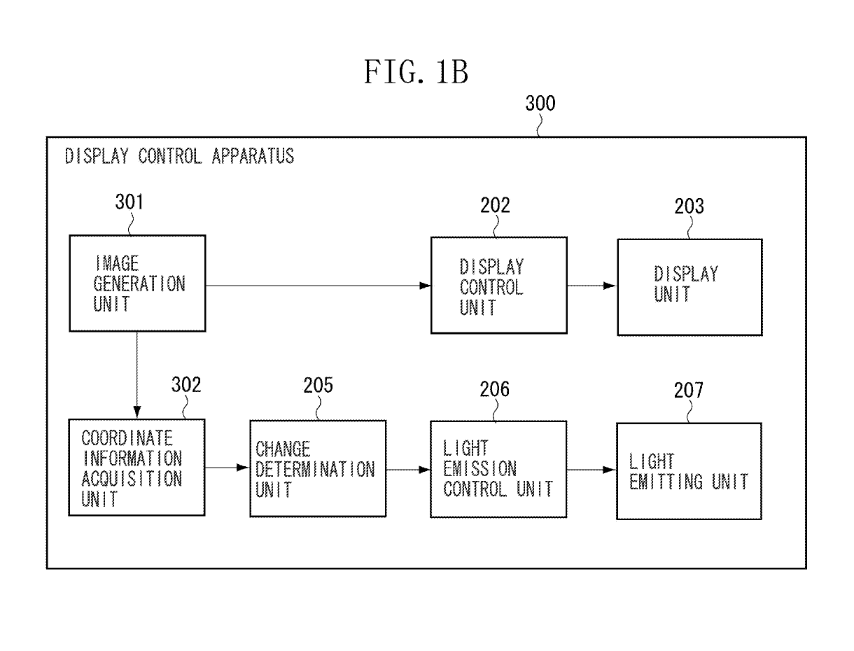

A first exemplary embodiment will be described below. FIGS. 1A and 1B illustrate a display control system and a display control apparatus according to the first exemplary embodiment. The display control system illustrated in FIG. 1A includes an image generation apparatus 100 and a display control apparatus 200. The image generation apparatus 100 includes an image output unit 101 and a coordinate information transmission unit 102. The image output unit 101 outputs an image stored in a storage unit (not illustrated) contained in the image generation apparatus 100 or an image from an external input apparatus (not illustrated) to the display control apparatus 200. The coordinate information transmission unit 102 outputs, to the display control apparatus 200, coordinate information regarding a display area of an object image contained in an image output by the image output unit 101 (hereinafter referred to as coordinate information of the object image).

The object image mentioned in this exemplary embodiment refers to a partial image contained in an image constituted of one frame (another image exists in an area other than the partial image). However, the object image mentioned in this exemplary embodiment is not limited to this example, but may be any partial image displayed just in part of the display unit (no video signal exists in an area other than the partial image). Specifically, the object image mentioned in this exemplary embodiment includes a GUI such as a menu screen, a reproduced image of a still image or a moving image, individual image display areas in multi-screen display, windows of personal computer (PC) applications and the like.

The display control apparatus 200 includes an image input unit 201, a display control unit 202, a display unit 203, a coordinate information acquisition unit 204, a change determination unit 205, a light emission control unit 206, and a light emitting unit 207. The image input unit 201 receives an image output by the image output unit 101 of the image generation apparatus 100 and transmits the received image to the display control unit 202. The display control unit 202 controls to display the image transmitted from the image input unit 201 on the display unit 203.

The coordinate information acquisition unit 204 acquires the coordinate information of the object image output by the coordinate information transmission unit 102 and transmits the coordinate information to the change determination unit 205. Based on the coordinate information of the object image, the change determination unit 205 determines whether at least anyone of the display position and the display area of the object image has been changed. In other words, the change determination unit 205 determines at least one of whether the display position of the object image has been moved and whether the display area of the object image has been enlarged or reduced.

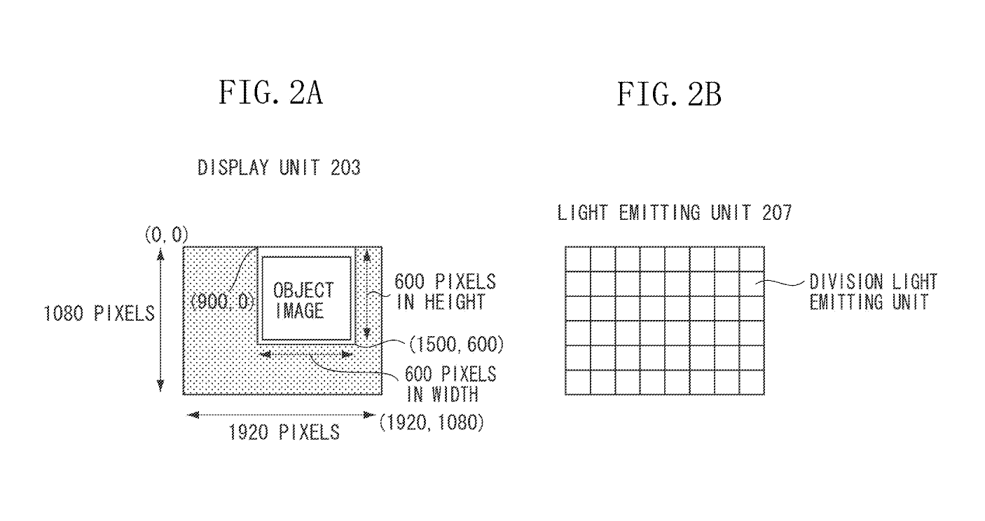

The coordinate information of the object image mentioned here is constituted of a top left coordinate and a bottom right coordinate of the object image in the display image. As illustrated in FIG. 2A, the coordinate information of the object image is constituted of a top left coordinate (900, 0) and a bottom right coordinate (1500, 600) in a display image of 1920×1080 pixels. The coordinate information of the object image is not limited to this example, but may be a coordinate of the center of the object image and size information (600 in height×600 in width pixels) of the object image. Alternatively, the coordinate information of the object image is at least any one of a coordinate of the center of the object image and size information of the object image.

Based on determination by the change determination unit 205, the light emission control unit 206 controls light emission of the light emitting unit 207. As illustrated in FIG. 2B, the light emitting unit 207 is constituted of a plurality of division light emitting units corresponding to a plurality of division areas prepared by dividing the display unit 203 configured to display an image. FIG. 2B illustrates a case where the light emitting unit 207 is constituted of 48 (8×6) division light emitting units. The light emission control unit 206 is capable of controlling the luminance of the plurality of division light emitting units independently.

The display control apparatus of the present invention may be configured, like a display control apparatus 300 illustrated in FIG. 1B, to include an image generation unit 301 in place of the image input unit 201 and a coordinate information acquisition unit 302 configured to acquire coordinate information of the object image from an image formed by the image generation unit 301. Furthermore, the display unit 203, the light emission control unit 206 and the light emitting unit 207 maybe configured to be a display unit separated from the display control apparatus 200 or 300.

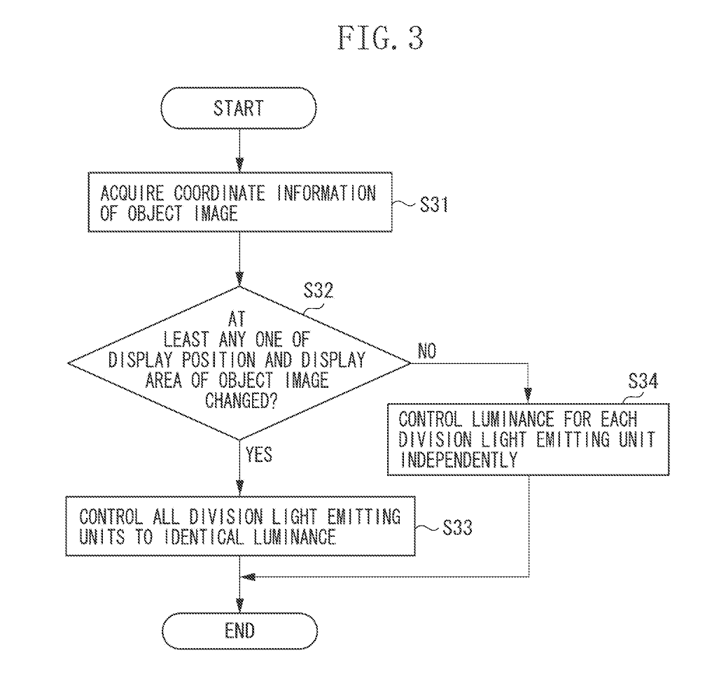

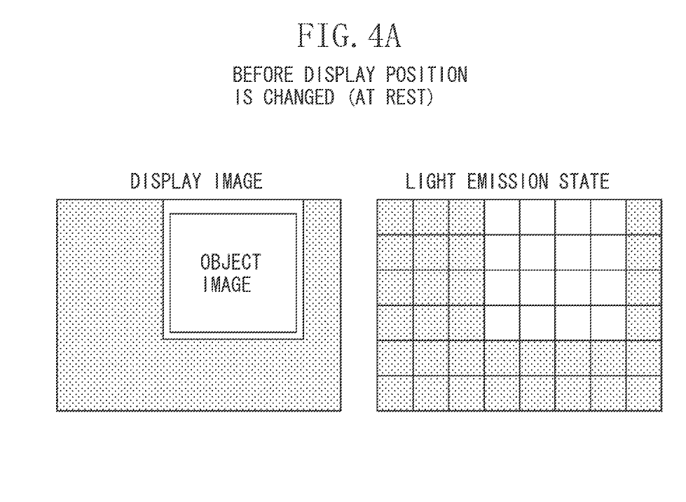

FIG. 3 illustrates a flow chart illustrating a processing of the display control apparatus 200. In step S31, the coordinate information acquisition unit 204 acquires coordinate information of an object image. In step S32, the change determination unit 205 determines whether at least any one of the display position and the display area of the object image has been changed, based on the coordinate information of the object image.

When in step S32, it is determined that the display position of the object image has been changed or the display area of the object image has been changed (YES in step S32), the processing proceeds to step S33. In step S33, the light emission control unit 206 controls all the plurality of division light emitting units of the light emitting unit 207 to emit light at a similar luminance. If the luminance of the plurality of division light emitting units is within a predetermined range, the luminance is regarded as similar.

If, in step S32, it is determined that the display position of the object image has not been changed and that the display area of the object image has not been changed (NO in step S32), the processing proceeds to step S34. In step S34, the light emission control unit 206 independently controls the luminance of the plurality of division light emitting units of the light emitting unit 207 according to the display image.

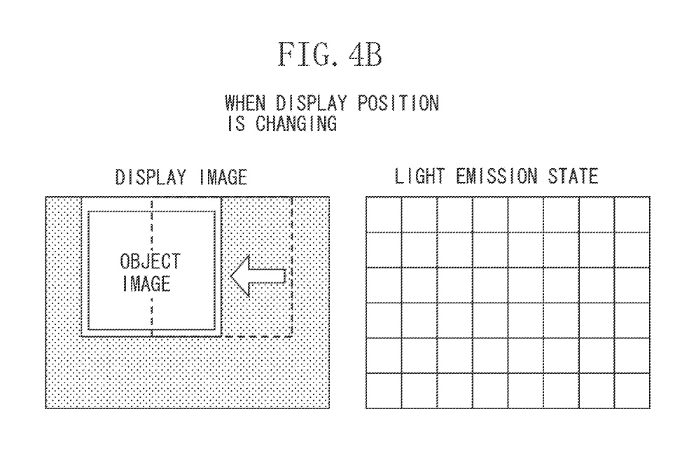

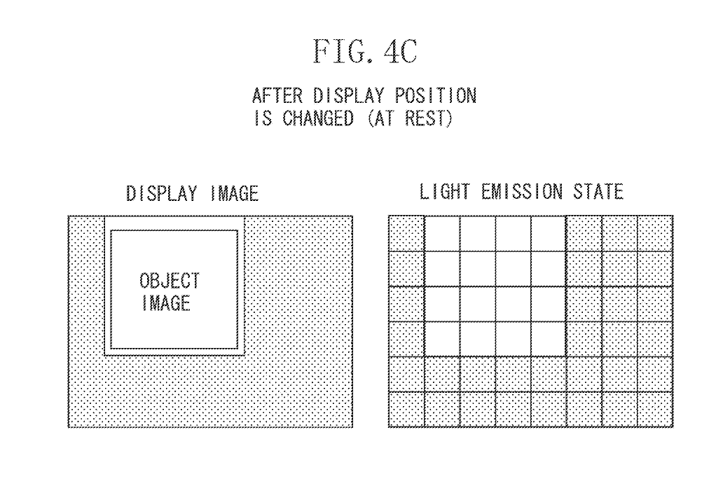

The display image on the display unit and the light emission state of the light emitting unit when the display position of the object image is changed will be described with reference to FIGS. 4A, 4B and 4C. A control of the light emission control unit 206 will be described below when the display position of the object image is moved (as illustrated on the left of FIG. 4B) from a display position of the object image indicated on the left of FIG. 4A to a display position of the object image indicated on the left of FIG. 4C.

If, as illustrated in the left figures of FIGS. 4A and 4C, the display position of the object image is not being changed, the light emission control unit 206 controls light emission of the plurality of division light emitting units of the light emitting unit 207 independently in response to the display image, as illustrated in the right figures of FIG. 4A and 4C. In the right figures of FIGS. 4A and 4C, the luminance of the division light emitting units (white area) corresponding to the display area of the object image is controlled to be higher than the division light emitting units (gray area) other than those corresponding to the display area of the object image. By controlling the luminance of the light emitting units independently (by local dimming control), the contrast of the display image can be intensified.

In a period when the display position of the object image is being changed as illustrated in the left figure of FIG. 4B, as illustrated in the right figure of FIG. 4B, the light emission control unit 206 controls all the division light emitting units contained in the light emitting unit 207 to emit light at an identical luminance. In other words, the light emission control unit 206 refrains from performing the local dimming control on the light emitting unit 207. In this case, assume that the luminance of each of the division light emitting units is equal to an average luminance of the light emitting unit 207 before the display position of the object image is changed, in other words, the average luminance of the light emitting unit 207 in FIG. 4A.

In the meantime, the luminance of the division light emitting unit in this case is not limited to the aforementioned value, but may be a luminance set preliminarily or an average luminance of the division light emitting units corresponding to the display area of the object image in FIG. 4A before the display position is changed. Further, the luminance of the division light emitting unit may be an average luminance of the division light emitting units corresponding to the display area other than the display area of the object image in FIG. 4A before the display position is changed. If the size of the display area of the object image is smaller than a predetermined value, setting the entire display area at an average luminance of the division light emitting units corresponding to the display area other than the display area of the object image minimizes a sense of discomfort when a user watches the screen.

By controlling the light emitting unit at an identical luminance as described above, deterioration of the image quality such as color unevenness at an end of the object image can be suppressed when the display position of the object image is being changed.

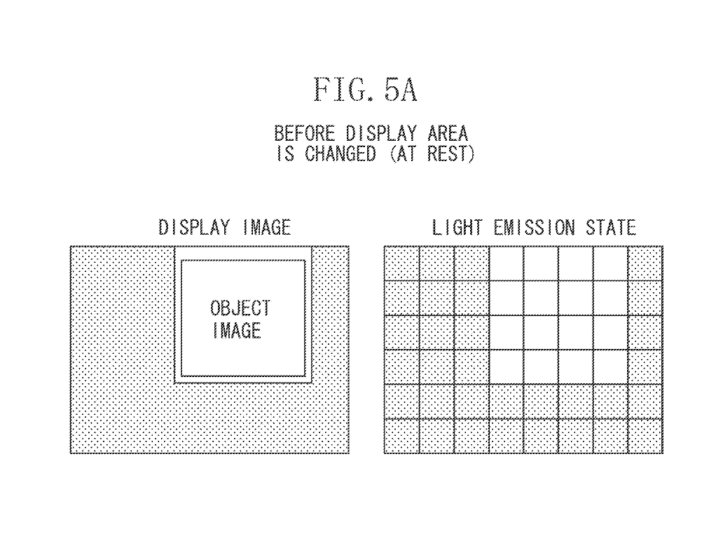

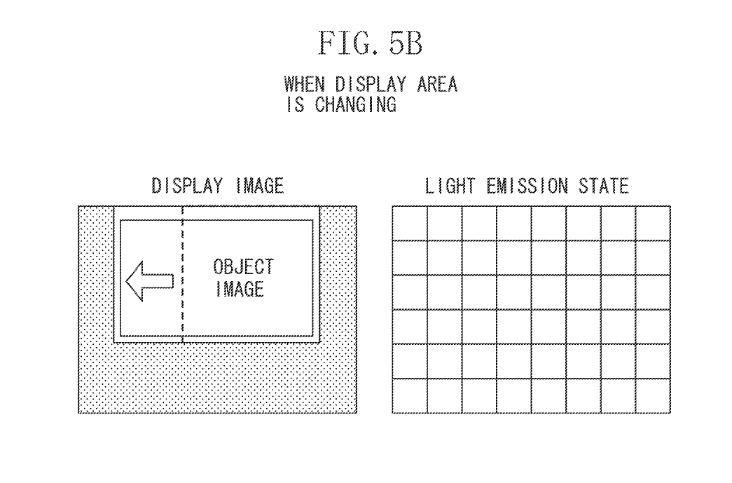

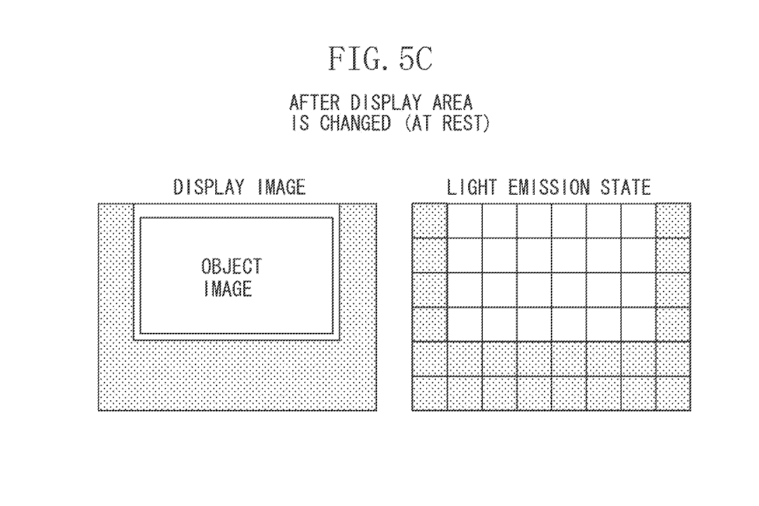

Next, a case where the display area of the object image was changed will be described with reference to FIGS. 5A, 5B and 5C. Control of the light emission control unit 206 will be described in a case where the display area of the object image is enlarged (as illustrated in the left figure of FIG. 5B) from the display area of the object image as illustrated in the left figure of FIG. 5A, up to the display area of the object image as illustrated in the left figure of FIG. 5C.

If, as illustrated in the left figures of FIG. 5A and 5C, the display area of the object image is not being changed, the light emission control unit 206 controls light emission of the plurality of division light emitting units in the light emitting unit 207 independently, as illustrated in the right figures of FIG. 5A and 5C. In the right figures of FIGS. 5A and 5C, the luminance of the division light emitting units corresponding to the display area of the object image is controlled to be higher than that of the division light emitting units other than those corresponding to the display area of the object image.

In the case when the display position of the object image is being changed, as illustrated in the left figure of FIG. 5B, as illustrated in the right figure of FIG. 5B, the light emission control unit 206 controls all the division light emitting units of the light emitting unit 207 to emit light at an identical luminance. In this case, assume that the luminance of each of the division light emitting units is equal to an average luminance of the light emitting unit 207 before the display area of the object image is changed, in other words, the average luminance of the light emitting unit 207 in FIG. 5A. However, the luminance of the division light emitting unit in this case is not limited to the aforementioned value, but may be a luminance set preliminarily or an average luminance of the division light emitting units corresponding to the display area of the object image in FIG. 5A before the display position is changed.

The control of the light emission control unit 206 when the display area of the object image is enlarged has been described above with reference to FIGS. 5A to 5C. When the display area of the object image is reduced, the light emission control unit 206 controls all the division light emitting units of the light emitting unit 207 to emit light at an identical luminance, as illustrated in FIG. 5B.

In above-discussed step S32 of FIG. 3, the change determination unit 205 may determine whether the display position of the object image has been changed equal to or more than a predetermined value in a unit time or whether the display area of the object image has been changed equal to or more than a predetermined value in a unit time. If a threshold is set for the change in the display position and the display area of the object image and the display position or the display area of the object image is changed equal to or more than the predetermined threshold, the light emission control unit 206 controls all the division light emitting units of the light emitting unit 207 at an identical luminance like in step S33. In step S32, whether the object image has been changed may be determined based on any one of the change in the display position and the change in the display area of the object image.

Although this exemplary embodiment has stated a case where one object image exists in a display image, the same processing as described above is carried out on each object image when a plurality of object images exist in the display image.

By controlling the plurality of division light emitting units to emit light at an identical luminance when at least one of the display position and the display area of the object image is changed, the deterioration of the image quality such as color unevenness at an end of the object image can be suppressed.

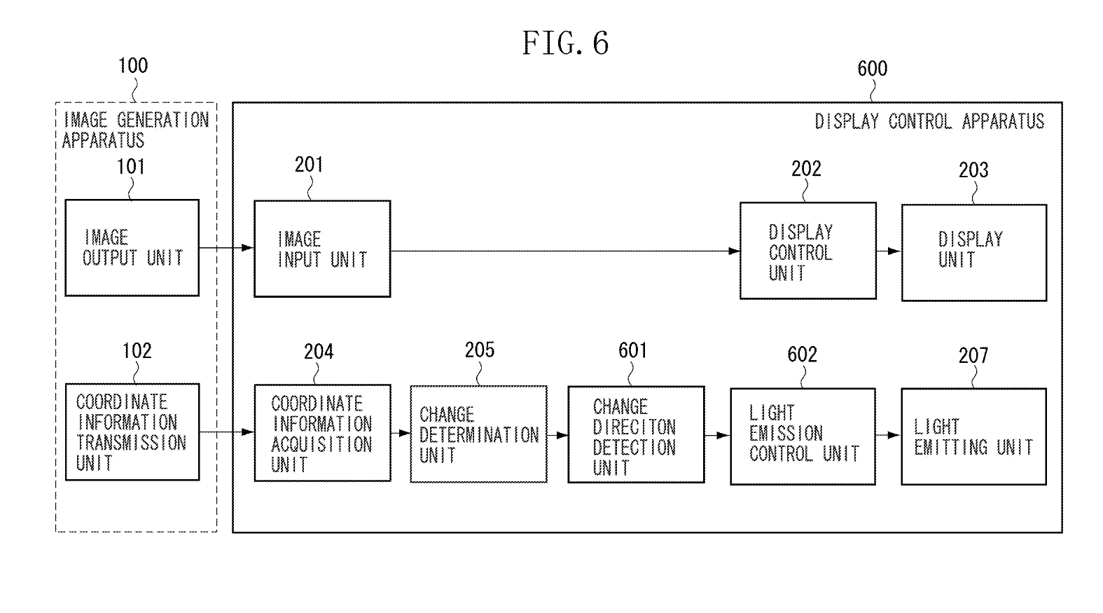

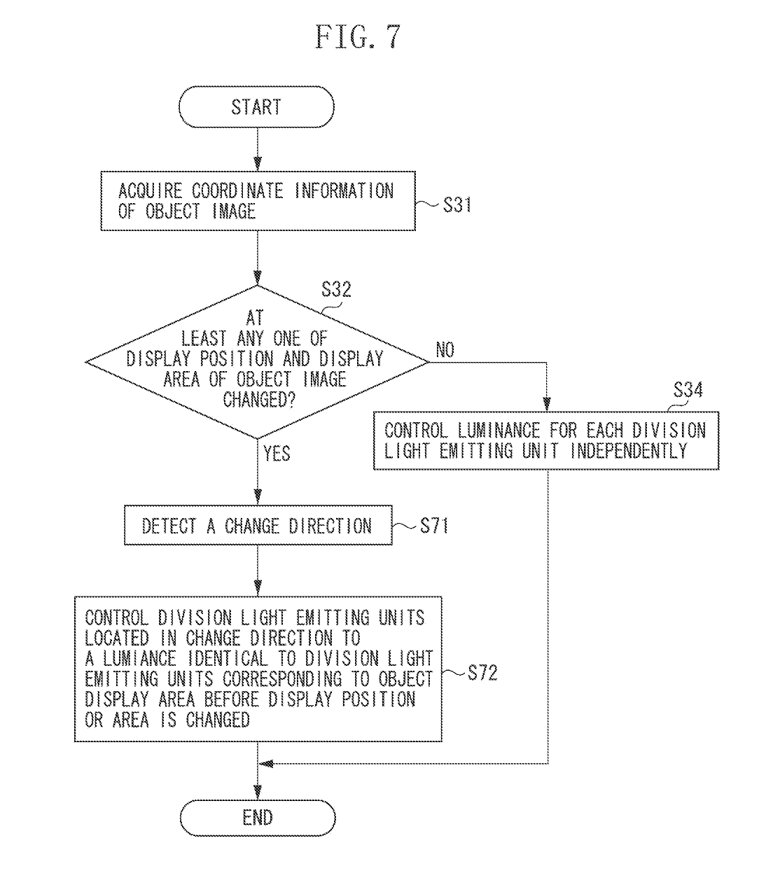

A second exemplary embodiment will be described below. FIG. 6 illustrates a display control system according to this exemplary embodiment. The display control system illustrated in FIG. 6 includes an image generation apparatus 100 and a display control apparatus 600. Description about blocks in which the same operation is executed as in the first exemplary embodiment is omitted while the same reference numerals are assigned to those blocks. Similarly to the display control apparatus of the first exemplary embodiment illustrated in FIG. 1B, the display control apparatus of the second exemplary embodiment may include the image generation unit 301 in place of the image input unit 201 and the coordinate information acquisition unit 302 configured to acquire coordinate information of the object image from an image generated by the image generation unit 301. The display unit 203, the light emission control unit 602 and the light emitting unit 207 may be provided in a display apparatus separated from the display control apparatus 600.

The second exemplary embodiment is different from the first exemplary embodiment in that the display control apparatus 600 has a change direction detection unit 601. When the change determination unit 205 determines that any one of the display position and the display area of the object image has been changed, the change direction determination unit 601 detects a direction of the change of the object image based on coordinate information of the object image. In other words, when the display position of the object image has been changed, the change direction determination unit 601 detects a direction of the change in the display position of the object image, and, when the display area of the object image has been changed, the change direction determination unit 601 detects a direction of the change in the display area of the object image. The change direction detection unit 601 sends a direction of the change in the display position of a detected object image or a direction of the change in the display area of the object image to the light emission control unit 602.

FIG. 7 illustrates a flow chart of a processing of the display control apparatus 600 according to the second exemplary embodiment. Description of the steps in which the same processing as the flow chart of FIG. 3 is executed is omitted while the same reference numerals are assigned to those steps. If, in step S32, the change determination unit 205 determines that any one of the display position and the display area of the object image has been changed, in step S71, the change direction determination unit 601 detects a direction of the change of the object image. If, in step S32, the change determination unit 205 determines that the display position of the object image has been changed (YES in step S32), in step S71, the change direction detection unit 601 detects the direction of the change in the display position of the object image. If, in step S32, the change determination unit 205 determines that the display area of the object image has been changed, in step S71, the change direction detection unit 601 detects the direction of the change in the display area of the object image.

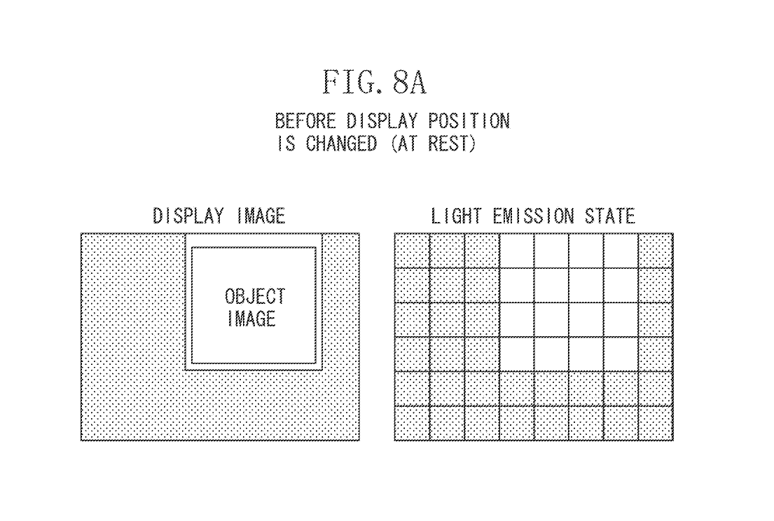

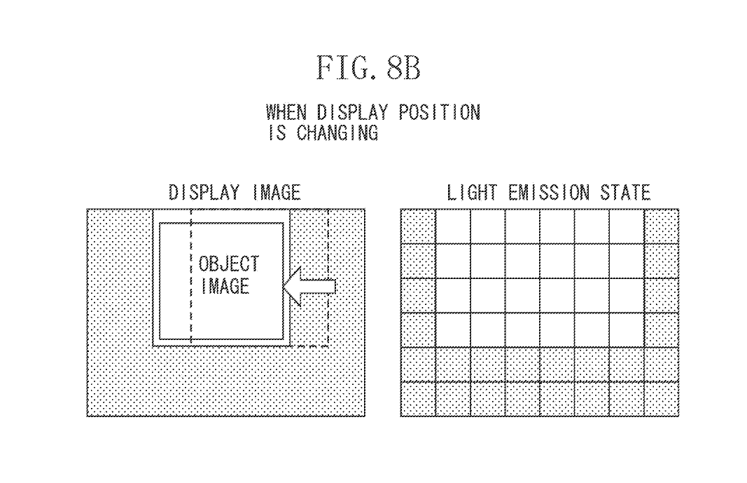

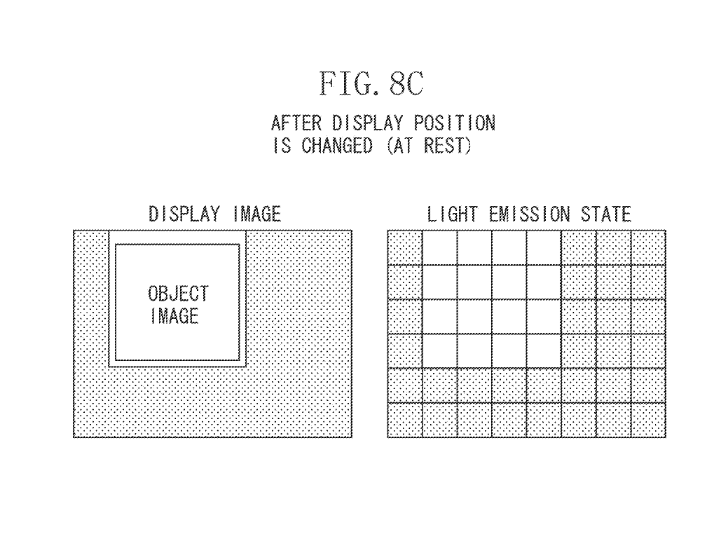

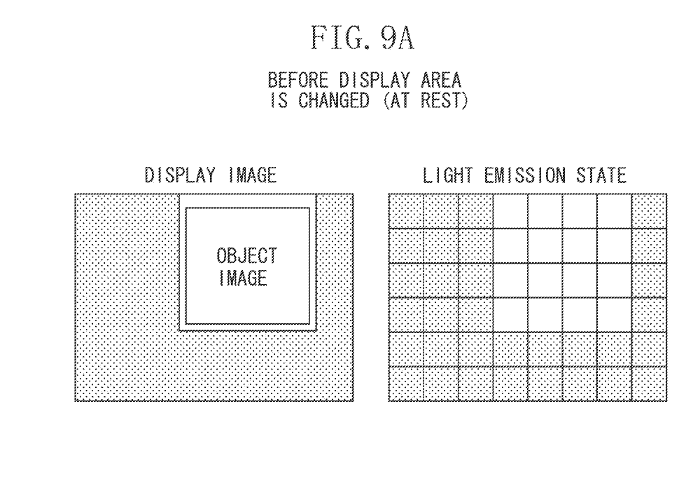

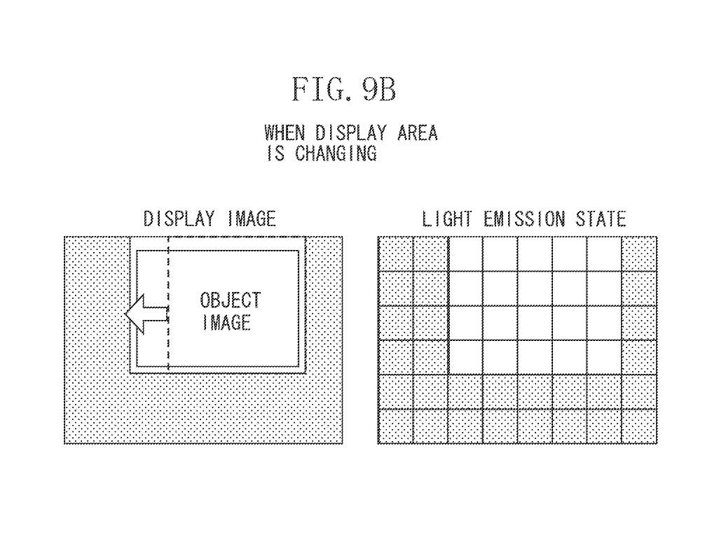

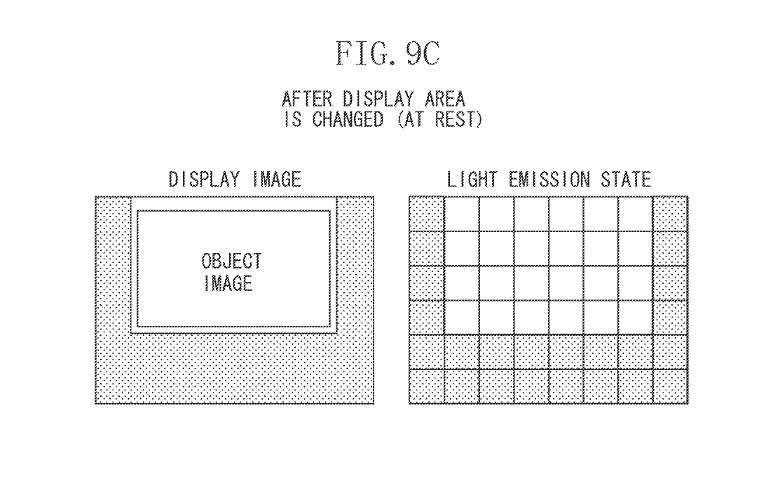

In step S72, the light emission control unit 602 makes division light emitting units in a change direction detected by the change direction detection unit 601 with respect to the division light emitting units corresponding to the display area of the object image before the display position has been changed to emit light at a luminance of the division light emitting units corresponding to the display area of the object image before the display position has been changed. A control of the light emission control unit 602 in this case will be described with reference to FIGS. 8A, 8B and 8C and FIGS. 9A, 9B and 9C. FIGS. 8A to 8C illustrate display images and light emission states of the light emitting unit when the display position of the object image is changed in the second exemplary embodiment. FIGS. 9A to 9C illustrate the display images and light emission states of the light emitting unit when the display area of the object image is changed in the second exemplary embodiment.

If the display position of the object image is not being changed as illustrated in the left figure of FIG. 8A and the left figure of FIG. 8C, the light emission control unit 602 controls light emission of the plurality of division light emitting units of the light emitting unit 207 independently in response to the display image.

When the display position of the object image is being changed as illustrated in the left figure of FIG. 8B, the light emission control unit 602 controls division light emitting units located in a change direction of the object image to emit light at a luminance identical to the division light emitting units corresponding to the display area of the object image before the display position has been changed. In the right figure of FIG. 8B, the light emission control unit 602 causes 6×4 division light emitting units to emit light at an identical luminance. The 6×4 division light emitting units constituted of 4×4 division light emitting units corresponding to the display area of the object image before the display position has been changed, and 2×4 division light emitting units on the left side (in the change direction) of the display area of the object image before the display position has been changed. In this case, it is permissible to cause 7×4 division light emitting units to emit light at an identical luminance to cause all the division light emitting units in the change direction of the object image to emit light. The 7×4 division light emitting units include 3×4 division light emitting units located on the left side with respect to the display area of the object image before the display position has been changed.

When the display area of the object image is not being changed as illustrated in the left figure of FIG. 9A and the left figure of FIG. 9C, the light emission control unit 602 controls light emission of the plurality of division light emitting units of the light emitting unit 207 independently in response to the display image in the same way as the right figure of FIG. 5A and the right figure of FIG. 5C of the first exemplary embodiment.

In the right figure of FIG. 9B, the light emission control unit 602 causes 5×4 division light emitting units to emit light at an identical luminance. The 5×4 division light emitting units are constituted of 4×4 division light emitting units corresponding to the display area of the object image before the display area has been changed, and 1×4 division light emitting units on the left side (in the change direction) with respect to the display area of the object image before the display area has been changed. In addition to the division light emitting units corresponding to the display area of the object image before the display area has been changed, the quantity and positions of the division light emitting units located in the change direction which the light emission control unit 602 causes to emit light may be determined in response to an amount of the change of the object image in a unit time or may be set preliminarily. When the object image is changed in the change direction detected by the change direction detection unit 601, it is advantageous that the division light emitting units which the light emission control unit 602 causes to emit light at a luminance identical to the division light emitting units corresponding to the display area of the object image before the display area has been changed are determined so that the luminance of the display area of the object image is identical to the luminance before the display area has been changed.

When the object image is changed, by causing the division light emitting units in the change direction with respect to the display area of the object image before the display area has been changed to emit light at a luminance identical to the division light emitting units corresponding to the display area of the object image, deterioration of the image quality such as color unevenness of the object image can be suppressed. Even when the local dimming control cannot be performed because of a large change in size of the object image, the division light emitting units in the change direction can be caused to emit light at a luminance identical to the division light emitting units corresponding to the display area of the object image by detecting the direction of the change.

While the present invention has been described with reference to exemplary embodiments, it is to be understood that the invention is not limited to the disclosed exemplary embodiments. It will of course be understood that this invention has been described above byway of example only, and that modifications of detail can be made within the scope of this invention.

What is claimed is:

1. A display control apparatus comprising:
a display control unit configured to perform control to display an image including a predetermined object on a screen of a display unit;
a light emission control unit configured to independently control light emission of each of a plurality of light emission units corresponding to a plurality of division areas constituting an area of the screen; and
a determination unit configured to determine whether a display area of the predetermined object on the screen changes,
wherein, in a case where the display area of the predetermined object on the screen is not changing, the light emission control unit controls light emission of each of the plurality of light emission units at a brightness corresponding to an image displayed on each of the plurality of division areas, and in a case where the display area of the predetermined object on the screen is changing, the light emission control unit controls light emission of each of the plurality of light emission units at a substantially same brightness corresponding to the predetermined object during changing, and controls light emission of each of the plurality of light emission units at a brightness corresponding to an image displayed on each of the plurality division areas after the change.

2. The display control apparatus according to claim 1, wherein the changing of the display area of the predetermined object is changing of a display position of the predetermined object on the screen.

3. The display control apparatus according to claim 1, wherein the changing of the display area of the predetermined object is changing of a display size of the predetermined object on the screen.

4. The display control apparatus according to claim 1, wherein the determination unit determines whether a display area of the predetermined object is changing based on coordinate information about a display area of the predetermined object on the screen.

5. The display control apparatus according to claim 1, wherein, in a case where a display position of the predetermined object is changing by equal to or more than a predetermined value in a unit time, the determination unit determines that a display area of the predetermined object is changing.

6. The display control apparatus according to claim 1, wherein, in a case where a display size of the predetermined object is changing by equal to or more than a predetermined value in a unit time, the determination unit determines that a display area of the predetermined object is changing.

7. The display control apparatus according to claim 1, wherein, in a case where a display area of the predetermined object includes two or more division areas, the light emission control unit controls light emission of all of the plurality of light emission units during the changing at average brightness of brightness corresponding to each of the two or more division areas before the changing.

8. The display control apparatus according to claim 1, wherein the display unit and the plurality of light emission units are included in the display control apparatus.

9. A display control method comprising:
displaying an image including a predetermined object on a screen of a display unit;
independently controlling light emission of each of a plurality of light emission units corresponding to a plurality of division areas constituting an area of the screen; and
determining whether a display area of the predetermined object on the screen changes,
wherein, in a case where the display area of the predetermined object on the screen is not changing, controlling light emission of each of the plurality of light emission units at a brightness corresponding to an image displayed on each of the plurality division areas, and in a case where the display area of the predetermined object on the screen is changing, controlling light emission of each of the plurality of light emission units at substantially a same brightness corresponding to the predetermined object during changing, and controlling light emission of each of the plurality of light emission units at a brightness corresponding to an image displayed on each of the plurality division areas after the change.

10. The display control method according to claim 9, wherein the changing of the display area of the predetermined object is changing of a display position of the predetermined object on the screen.

11. The display control method according to claim 9, wherein the changing of the display area of the predetermined object is changing of a display size of the predetermined object on the screen.

12. The display control method according to claim 9, wherein the determination unit determines whether a display area of the predetermined object is changing based on coordinate information about a display area of the predetermined object on the screen.

13. The display control method according to claim 9, wherein, in a case where a display position of the predetermined object is changing by equal to or more than a predetermined value in a unit time, it is determined that a display area of the predetermined object is changing.

14. The display control method according to claim 9, wherein, in a case where a display size of the predetermined object is changing by equal to or more than a predetermined value in a unit time, it is determined that a display area of the predetermined object is changing.

15. The display control method according to claim 9, wherein, in a case where a display area of the predetermined object includes two or more division areas, controlling the light emission of all of the plurality of light emission units during the change at average brightness of brightness corresponding to each of the two or more division areas before the change.
